(19) United States
(12) Patent Application Publication
(10) Pub. No.: US 2002/0013838 A1
(43) Pub. Date: Jan. 31, 2002

(54) Method and system to select the highest speed server among web servers

(76) Inventors: Takayuki Kushida, Haramachida (JP); Tatsuo Miyazawa, Kawasaki-shi (JP)

Correspondence Address: Ronald L. Drumheller. Esq., 94 Teakettle Spout Road, Mahopac, NY, 10541, US

(21) Appl. No.: 09/963,013

(22) Filed: Sep. 25, 2001

(30) Foreign Application Priority Data
Feb. 5, 2000 (JP) 2000-133165

(51) Int. Cl. G06F 15/173

(52) U.S. Cl. 709/223

(57) ABSTRACT

When a content request is issued by a client to a plurality of web servers, to which the client is connected via a network, each of the plurality of web servers having the same requested content, the web servers is selected that can provide the requested content for the client at the highest speed. To do this, one of the web servers performs the following steps: (1) a step of receiving the content request from the client; (2) a step of measuring the performance of a network information transfer for the client; (3) a step of requesting that the remaining web servers measure the performance of a network information transfer for the client; (4) a step of receiving from each of the remaining web servers the results obtained by measuring the performance of the network information transfer; and (5) a step of employing the results of the measurements of the performances of the network information transfer provided by all of the servers to select the web server that can provide the best transfer performance for the client.

### BACKGROUND OF THE INVENTION

1. Field of the Invention

The present invention relates to a high-speed web server selection method and system, and relates in particular to a method and a system for selecting, from among a plurality of web servers, a server that can quickly provide content for a client, and a storage medium on which a high-speed web server selection program is stored.

2. Related Art

The Internet is a network that is based on the exchange of information using packets with variable lengths On this network, routers, for transferring packets, that are located along packet transfer routes refer to destination addresses included in the headers of received packets, compare the addresses with route entries in locally available route tables, and transmit the packets to the next hosts that are included in the entries that have been matched. Because of these packet transfer procedures that are performed en route, a packet is repeatedly transmitted until it finally arrives at the destination host. Further, since a packet is merely transferred when an entry has been matched, no guarantee is provided concerning the security of information.

In order to establish a reliable path between two arbitrary hosts on the Internet, generally TCP (Transmission Control Protocol) is employed. According to this protocol, when, for a specific reason, a packet is damaged or lost en route, this is detected by the host at the final destination, and a data recovery process is initiated to request that the packet be retransmitted. By using this data recovery system, a reliable virtual path can be established between two hosts on the Internet. Further, an algorithm for avoiding heavy traffic en route is also incorporated. However, TCP does not have a function for guaranteeing delay time. In other words, QOS (Quality Of Service) is not ensured between hosts connected to the Internet. Furthermore, a service related to bandwidth and delays can not be provided via the Internet, unlike via a dedicated line connection.

This technical limitation constitutes a problem in that it is impossible to predict bandwidth and delay time when an arbitrary client and a server exchange data content. And since the service employed for the Internet is generally the client-server type, all the services are affected by the above problems. That is, conventionally, a problem exists in that services provided along special lines or VANs can not be duplicated on the Internet. And when there is a concentration of accesses at a specific router on the Internet, or when the band at the en route link is too narrow, accesses tend to accumulate and to exceed the capacity of the band used for traffic, and traffic congestion ensues. Therefore, when packets travel along this route their transfers is delayed due to the traffic congestion, or packets are dropped by the router at a specific rate, without being transferred to the next host.

The current Internet application that is used the most is the WWW (World Wide Web). On the WWW, HTTP (Hyper Text Transfer Protocol), a simple client-server type protocol that uses TCP, is employed. But between a WWW client and a WWW server, the transfer performance is also sometimes reduced due to traffic congestion en route. And this constitutes a problem in that the quality of the network service is deteriorated, and accordingly, for an end user usability is also deteriorated.

To resolve the above problems, there have been proposed a method for performing a manual search for a nearby host, a method for dispersing a load imposed on a host at which many accesses have concentrated, and a method for providing special measurement software for a client to be used for measuring the delay times at a server. However, no method has been provided for efficiently selecting a server that has provided an excellent performance.

### SUMMARY OF THE INVENTION

It is one object of the present invention to provide a method and a system for suppressing the reduction of the speed across the Internet of a transfer effected between a client and a server.

It is another object of the present invention to provide a method and a system for improving the usability of the Internet for an end user.

It is an additional object of the present invention to provide a method and a system for minimizing transfer delays from a web server on the Internet that has the same content.

It is a further object of the present invention to provide a method and a system for selecting a web server in order to avoid congested network areas.

It is a still further object of the present invention to provide a method and a system for the high speed selection of a server without any special software being required for a client.

It is one more object of the present invention to provide a method and a system for providing, for a web user, a web service for which there is only a small network delay, without changing the conventional web contents and the environment of a client.

To achieve the above objects, according to one aspect of the present invention, a high-speed web server selection method is provided for, when a content request is issued by a client to a plurality of web servers, to which the client is connected via a network, having the same content, selecting one of the web servers that can at high speed provide the requested content for the client, one of the web server performing: (1) a step (S310 in FIG. 3) of receiving the content request from the client; (2) a step (S320 in FIG. 3) of measuring the performance of a network information transfer for the client; (3) a step (S330 in FIG. 3) of requesting that the remaining web servers measure the performance of a network information transfer for the client; (4) a step (S340 in FIG. 3) of receiving from each of the remaining web servers the results obtained by measuring the performance of the network information transfer; and (5) a step (S350 in FIG. 3) of employing the results of the measurements of the performances of the network information transfer provided by all of the servers to select the web server that can provide the best transfer performance for the client.

Further, the web server comprises a step (S540 in FIG. 5) of replacing the host name in link information, used to designate the location of content, with the host name of the web server that is selected.

In addition, the network information transfer performance is obtained by measuring a delay time between the client and each of the web servers, and the web server that has the shortest delay time is selected as the web server that can provide the best transfer performance for the client (S530 in FIG. 5).

The step (5) of selecting the web server includes a step of storing the results obtained by measuring the performances of the network information transfer, and of, when the same client issues another content request, employing the results to select the web server that can provide the best transfer performance, while skipping the process for the measurement of the performances of the network information transfer.

According to another aspect of the invention, a high-speed web server selection system is provided for selecting, from among a plurality of web servers having the same content, a web server that can (at high speed) transmit content to a client who has issued a request for the content, one of the web servers comprising: (1) means for receiving the content request from the client; (2) means for measuring the performance of a network information transfer for the client; (3) means for requesting that the remaining web servers measure the performance of a network information transfer for the client; (4) means for receiving from each of the remaining web servers the results obtained by measuring the performance of the network information transfer; and (5) means for employing the results of the measurements of the performances of the network information transfer provided by all of the servers to select the web server that can provide the best transfer performance for the client.

Further, the web server comprises means for replacing the host name in link information, used to designate the location of content, with the host name of the web server that is selected.

In addition, the network information transfer performance is obtained by measuring a delay time between the client and each of the web servers, and the web server that has the shortest delay time is selected as the web server that can provide the best transfer performance for the client.

The means (5) for selecting the web server includes means for storing the results obtained by measuring the performances of the network information transfer, and for, when the same client issues another content request, employing the results to select the web server that can provide the best transfer performance, while skipping the process for the measurement of the performances of the network information transfer.

According to an additional aspect of the invention, a computer-readable storage medium on which a high-speed web server selection program is recorded for the selection, from among a plurality of web servers having the same content, a web server that can (at high speed) transmit content to a client who has issued a request for the content, the high-speed web server selection program permitting a computer to perform: (1) a function for receiving the content request from the client; (2) a function for measuring the performance of a network information transfer for the client; (3) a function for requesting that the remaining web servers measure the performance of a network information transfer for the client; (4) a function for receiving from each of the remaining web servers the results obtained by measuring the performance of the network information transfer; and (5) a function for employing the results of the measurements of the performances of the network information transfer provided by all of the servers to select the web server that can provide the best transfer performance for the client.

### BRIEF DESCRIPTION OF THE DRAWINGS

FIG. 1 is a diagram showing the general configuration of a system according to the present invention.

FIG. 2 is a diagram showing the arrangement of a web server A 120.

FIG. 3 is a flowchart showing the fast server selection processing.

FIG. 4 is a flowchart showing the processing performed for estimating a delay time for the client.

FIG. 5 is a detailed flowchart showing the fast server selection processing.

FIG. 6 is a diagram showing the arrangement of a web server B 130.

FIG. 7 is a diagram showing an example hardware arrangement for a web server and a client according to the present invention.

### DESCRIPTION OF THE PREFERRED EMBODIMENTS

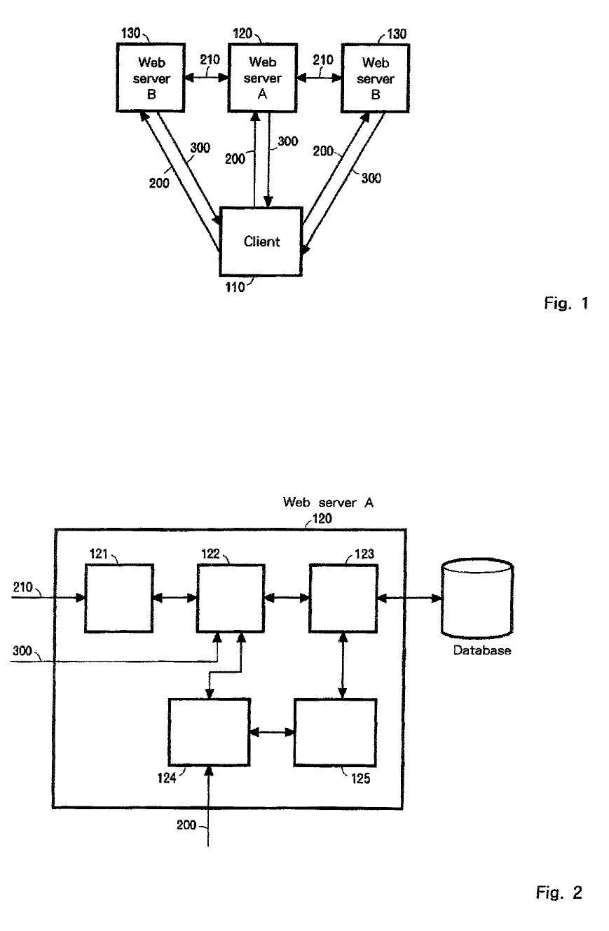

FIG. 1 is a diagram showing the general configuration of a system according to the present invention. In FIG. 1, a web client 110, which is an ordinary web browser, issues an HTTP request to a web server and receives and displays its response. A web server A 120 and a web server B 130 include not only a normal web server function, but also a function for measuring network information transfer performance, and a function for establishing connections between servers. It is preferable that between the servers the Inter-Server Protocol be used.

In FIG. 1, when the web client 110 issues the common HTTP Get Request to the web server A 120, the web server A 120 requests that multiple web servers B 130 measure the delay time for the web client 110. Upon the receipt of the request, the individual web servers B 130 measure the delay time for the web client 110. The web server A 120 also individually measures the delay time for the web client 110.

As a result, a plurality of delay times for the web client 110 are collected from the web server A 120 and the web servers B 130. Analyzation of these results is then performed, and which web server is the closest to the web client 110 is determined. If this web server is a web server C, the name of the host at the location of an HTML file whereat the web server name is written is replaced with the name of the web server C. The web client 110 receives the corrected HTML file, and based on this HTML file, can access the fastest web server to obtain the requested content.

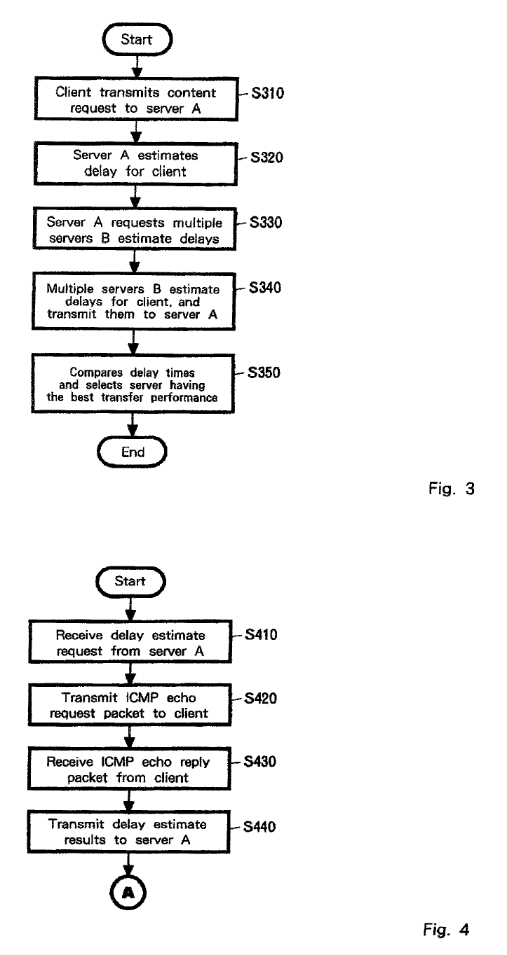

FIG. 3 is a flowchart showing the processing performed for selecting a server that can provide the content to the client at high speed upon the receipt of a content request from the client. First, at step S310, one of the web servers receives a content request from the client. At step S320, the web server estimates the delay time for the client. At step S330, the web server requests that the other web servers estimate the delay times between the client and themselves. At step S340, the web server receives the estimated delay times prepared by the other web servers. Finally, at step S350, the web server employs the estimated delay times prepared by all the web servers to select the web server that can provide the best transfer performance for the client.

The web servers A 120 and B 130 in FIG. 1 will now be described in detail. FIG. 2 is a diagram showing the internal arrangement of the web server A 120. As is shown in FIG. 2, the web server A 120 comprises: an inter-web server communication unit 121; a delay estimation unit 122, a database management unit 123, a web server component unit 124 and a web component correction unit 125. The inter-web server communication unit 121 transmits as a parameter the IP address of a client to a plurality of web servers, to request that they individually measure the delay time to the client. The delay estimation unit 122 measures a delay for the client, compares this delay time with the delay times obtained from the other web servers, and determines an optimal time. The database management unit 123 has a function for storing in the database traffic data collected in the past. The web server component unit 124 has an ordinary web server function. And the web component correction unit 125 analyzes the pertinent web page, and corrects the name of a host in the link portion.

FIG. 6 is a diagram showing the arrangement of the web server B 130. The web server B 130 comprises an inter-web server communication unit 131, a delay estimation unit 133 and a web server component unit 132. The inter-web server communication unit 131 receives a delay estimate request from the web server A 120, and returns, to the web server A 120, an estimate prepared by the delay estimation unit 133. The delay estimation unit 133 estimates the delay time for the client, and transmits the results to the inter-web server communication unit 131. The communication between servers is performed by the inter-web server communication unit 121 and the inter-web server communication unit 131 using an inter-server protocol 210. The arrangement used for the web server A may be employed for each web server B because the arrangement used for the web server A includes all the components in the arrangement for the web server B. In short, the same arrangement may be employed for all the web servers.

A delay time measurement process 300 is performed as follows. The delay estimation units 122 and 133 of the web server A 120 and the web servers B 130 transmit N ICMP echo request packets to the client 110, and each receives an ICMP echo reply packet from the client 110. Each delay estimation unit 122 or 133 calculates a difference between the time at which the ICMP echo request packet was transmitted and the time at which the ICMP echo reply packet, and defines the difference as the delay time. Preferably, the measurement of the delay time is repeated a plurality of times.

The analyzation of the delay time will now be described in detail. Generally, since the delay time measured on the Internet varies, an accurate delay time can not be obtained by using only one measurement. Therefore, in this invention, a packet of m bytes is transmitted to the client and the delay time is measured. Then, after this measurement has been repeated N times, the final delay time is determined. It is preferable, for analyzation of the delay time, that one of the following two delay times be employed as a delay time between a web server and a client:

(1) Delay time using a center value (Mₑ) when N is an odd number, Tₑ=T_{((N-1)/2+1)} when N is an even number, Tₑ=(T_{N/2}+T_{(N/2+1)})/2;

(2) Delay time using an average value (Mₐᵥ) Tₐᵥ=(ΣT₁)/N (where i=1, . . . , N)

Assume that the delay time from the web server A 120 to the client 110 in FIG. 1 is defined as T_{AC}, the delay time from the web server B 130 to the client 110 is defined as T_{BC1}, and the delay time to the other web server B is defined as T_{BC2}. When the measurement results are obtained by the three servers as follows:

T_{BC1}<T_{AC}<T_{BC2},

T_{BC} is the minimum delay, so that the web server B (B1) is found to be the closest server to the client 110. Thus, a link relative to the same host in the HTML file, which is included in the response to the HTTP Get Request of the client 110, is corrected as follows:

<a href=“http://B1/contents.html”>

Because of this correction, the HTML file, wherein the link is corrected to reflect the name of the server having the shortest delay time, can be transmitted to the client 110.

Upon the receipt of the HTML file, the client 110 displays the HTML, and when the link location is clicked on by the web browser of the client 110, the HTTP Get Request is issued to the server that can be accessed within the shortest time, so that desired content can be obtained quickly. It should be noted that the web component correction unit 125 is in charge of the HTML correction. During the correction process for the HTML file contents, the host name entered in the link information is replaced with an obtained host name.

FIG. 4 is a flowchart showing the processing performed when a delay time between the web server B 130 and the client 110 is estimated. At step S410 the web server B 130 receives, from the web server A 120, a request that an estimated delay time be prepared. At step S420, the web server B 130 transmits an ICMP echo request packet to the client 110, and at step S430, the web server B 130 receives an ICMP echo reply packet from the client 110. Finally, the web server B 130 transmits, to the web server A 120, the results obtained for the delay time estimation.

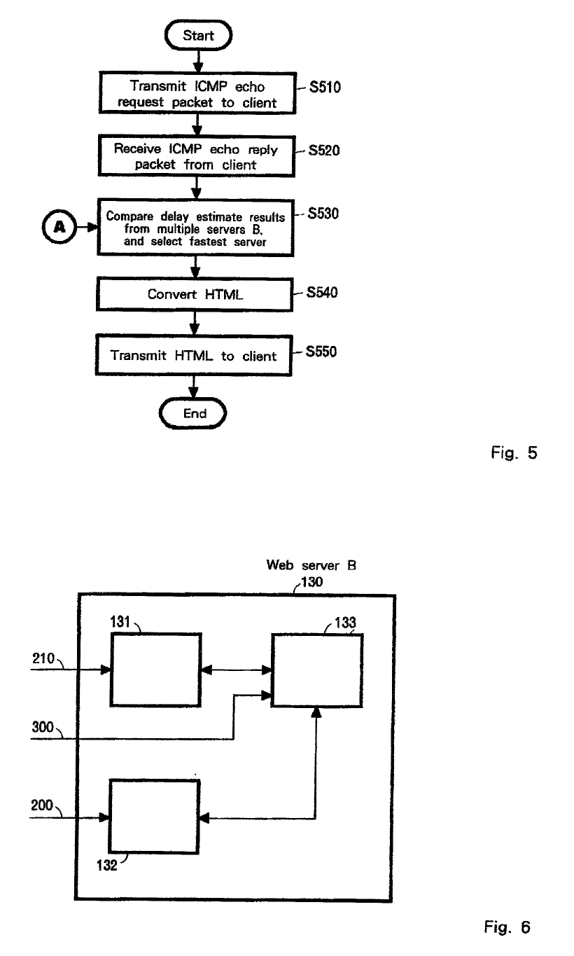

FIG. 5 is a flowchart showing the processing for estimating a delay time between the web server A 120 and the client 110 and for selecting a high-speed server. At step S510, the web server A 120 issues an ICMP echo request packet to the client 110, and at step S520 the web server A 120 receives an ICMP echo reply packet from the client 110. The web server A 120 compares the estimated delay time with the estimated delay times received from the web servers B 130, and at step S530, selects the fastest server. At step S540, the HTML file including the information for linking to the contents is changed, and at step S550, the resultant HTML file is transmitted to the client 110.

The method of the invention can be scalably employed in the same manner for many web servers. If the number of web servers is increased, the time is extended by a length of time that is equivalent to the transmission of an inquiry to each web server. Therefore, for example, an inquiry is issued to ten servers that are selected at random, and a server who transmits a reply within the shortest time is employed. In this case, although the best results may not be employed for all the servers, locally good results are obtained.

Since the pair of the client and the server that was optimal in the past is stored in a table, the waiting time that is required for the completion of the measurement can be reduced and the performance can be improved. It is preferable, however, that the table be erased periodically and updated. Further, when this table is stored in each server, the client can be notified of the optimal server, regardless of which server receives the request from the client. Further, between the web servers, the delay time for a client that frequently accesses the server is frequently exchanged asynchronously with a request that is issued each time. When the time to the client is exchanged by web servers, a client that frequently employs the network system can always access the latest server that provides a superior performance. Furthermore, according to the invention, the delay time between the web server and the client is measured to examine the network information transfer performance. However, another network performance index, such as a network band, a network speed, an error rate or a retry count may be employed to modify the present invention without departing from the scope of the invention.

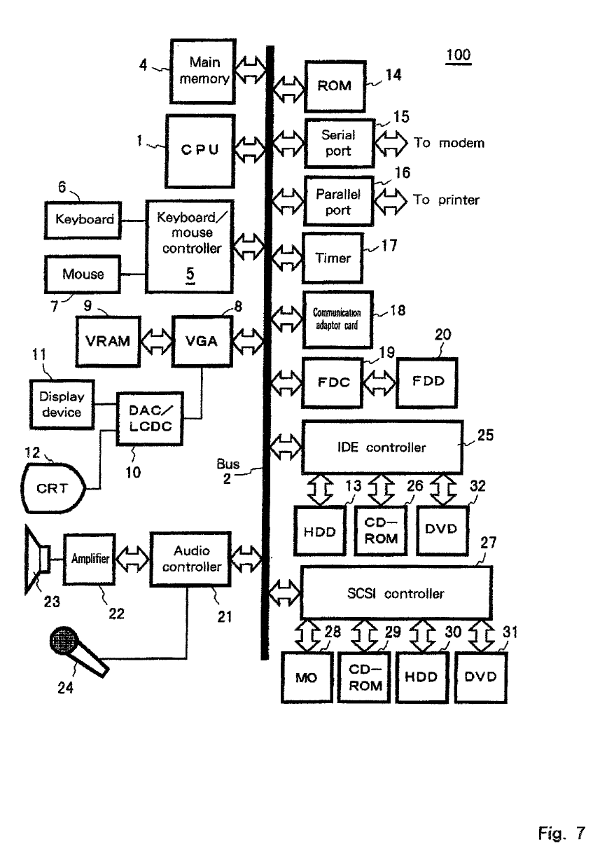

FIG. 7 is a schematic diagram illustrating a hardware configuration for the web server and the web client used for the present invention. A system 100 comprises a central processing unit (CPU) 1 and a main memory 4. The CPU 1 and the main memory 4 communicate via a bus 2 and an IDE controller 25 with a hard disk drive HDD 13 (or another storage medium, such as a CD-ROM 26 or a DVD 32), which is an auxiliary storage device. The CPU 1 and the main memory 4 are also connected via the bus 2 and a SCSI controller 27 to a hard disk drive 30 (a drive for a storage medium, such as an MO 28, or a CD-ROM drive 29 or a DVD 31), which is an auxiliary storage device. A floppy disk drive 20 is connected to the bus 2 via a floppy disk controller (FDC) 19.

A browser program, code for an operating system, an inter-web server communication program, a delay estimation program, a database management program, a web server component, a web component correction program, and other data, all of which are used, in coordination with an operating system, to issue instructions to the CPU 1 and to implement the provisions of the present invention, are stored on a floppy disk (or another storage medium, such as a CD-ROM 26 or a DVD 32) that is inserted into the floppy disk drive 20, on the hard disk drive 13 and in a ROM 14. These programs or data can be loaded into the memory 4 for execution. The code for these computer programs can be compressed, or can be divided into a plurality of code segments and recorded using a plurality of media.

The system 100 further includes user interface hardware, the components of which include a pointing device (a mouse, a joy stick, etc.) 7 or a keyboard 6, for entering data, and a display 12, for browsing a web site. Preferably, the contents of a web server are browsed on the display 12 using the pointing device 7. Further, a printer can be connected via a parallel port 16, or a modem can be connected via a serial port 15. This system 100 is connected to a network via the serial port 15 and the modem, or via a communication adaptor 18 (an ethernet or a token ring card) to communicate with another computer or another server. It is preferable that the inter-web server communication unit communicate with another web server or a client via the modem or the communication adaptor. The web site including the content is generally connected via the Internet; however, it may be connected via a local web server in a WAN or a LAN, and either way does not limit the execution of the present invention. Further, a remote transceiver may be connected to the serial port 15 or to the parallel port 16 for the exchange of data using infrared rays or radio waves.

A loudspeaker 23 receives D/A (digital/analog) converted sounds or tone signals from an audio controller 21 via an amplifier 22, and releases them as sound or speech. The audio controller 21 also performs an A/D conversion for speech information input at a microphone 24 to carry the speech information outside the system. An application, such as ViaVoice (a trademark of IBM) may be employed to replace the manual operation of a GUI command unit of the present invention with an operation using speech commands. Further, an application, such as a homepage reader (a trademark of IBM), may be employed to read web site information on the display, so that desired contents can be requested from a web server.

It would therefore be easily understood that the user information terminal 130 of the present invention can be provided by employing an ordinary personal computer (a PC); a work station; a notebook PC; a palm top PC; a network computer; various types of electric home appliances, such as televisions, that incorporate a computer; a game machine having a communication function; a communication terminal device, such as a telephone, a facsimile machine, a portable telephone, a PHS or a PDA; or a combination of these apparatuses. The above described components, however, are merely examples, and not all of them are required for the present invention.

According to the present invention, the delay a client encounters with web servers on the Internet that have the same content can be minimized. With the arrangement of the present invention, congested network areas can be avoided. And since according to the method of the invention, all of the required software is available at a server, a client need only prepare a standard web browser, and requires no dedicated software. According to the present invention, on a network, a web service having only a small delay can be provided for a web user, without changing the conventional web content and the conventional environment of the client.

1. A high-speed web server selection method for, when a content request is issued by a client to a plurality of web servers, to which said client is connected via a network, having the same content, selecting one of said web servers that can at high speed provide said requested content for said client, one said web server performing:
(1) a step of receiving said content request from said client;
(2) a step of measuring the performance of a network information transfer for said client;
(3) a step of requesting that the remaining web servers measure the performance of a network information transfer for said client;
(4) a step of receiving from each of said remaining web servers the results obtained by measuring said performance of said network information transfer; and
(5) a step of employing said results of said measurements of said performances of said network information transfer provided by all of said servers to select the web server that can provide the best transfer performance for said client.

2. The high-speed web server selection method according to claim 1, wherein said web server performs a step of replacing host name in link information, used to designate the location of content, with the host name of said web server that is selected.

3. The high-speed web server selection method according to claim 1, wherein said network information transfer performance is obtained by measuring a delay time between said client and each of said web servers; and wherein the web server that has the shortest delay time is selected as said web server that can provide the best transfer performance for said client.

4. The high-speed web server selection method according to claim 1, wherein said step (5) of selecting said web server includes: a step of storing said results obtained by measuring said performances of said network information transfer, and of, when said same client issues another content request, employing said results to select the web server that can provide the best transfer performance, while skipping the process for the measurement of said performances of said network information transfer.

5. A high-speed web server selection system for selecting, from among a plurality of web servers having the same content, a web server that can (at high speed) transmit content to a client who has issued a request for said content, one of said web servers comprising:
(1) means for receiving said content request from said client;
(2) means for measuring the performance of a network information transfer for said client;
(3) means for requesting that the remaining web servers measure the performance of a network information transfer for said client;
(4) means for receiving from each of said remaining web servers the results obtained by measuring said performance of said network information transfer; and
(5) means for employing said results of said measurements of said performances of said network information transfer provided by all of said servers to select the web server that can provide the best transfer performance for said client.

6. The high-speed web server selection system according to claim 5, wherein said web server comprises: means for replacing host name in link information, used to designate the location of content, with the host name of said web server that is selected.

7. The high-speed web server selection system according to claim 5, wherein said network information transfer performance is obtained by measuring a delay time between said client and each of said web servers, and the web server that has the shortest delay time is selected as said web server that can provide the best transfer performance for said client.

8. The high-speed web server selection system according to claim 5, wherein said means (5) for selecting said web server includes: means for storing said results obtained by measuring said performances of said network information transfer, and for, when said same client issues another content request, employing said results to select the web server that can provide the best transfer performance, while skipping the process for the measurement of said performances of said network information transfer.

9. A computer-readable storage medium on which a high-speed web server selection program is recorded for the selection, from among a plurality of web servers having the same content, a web server that can (at high speed) transmit content to a client who has issued a request for said content, said high-speed web server selection program permitting a computer to perform:
(1) a function for receiving said content request from said client;
(2) a function for measuring the performance of a network information transfer for said client;
(3) a function for requesting that the remaining web servers measure the performance of a network information transfer for said client;
(4) a function for receiving from each of said remaining web servers the results obtained by measuring said performance of said network information transfer; and
(5) a function for employing said results of said measurements of said performances of said network information transfer provided by all of said servers to select the web server that can provide the best transfer performance for said client.
